(19) United States
(12) Patent Application Publication
(10) Pub. No.: US 2008/0215627 A1
(43) Pub. Date: Sep. 4, 2008

(54) Standardized health data hub

(75) Inventors: Rose Higgins, Washington Crossing, PA (US); Jeffrey James Webber, Vista, CA (US); Toni Tapio Pakarinen, Cupertino, CA (US)

Correspondence Address: BEYER WEAVER LLP, P.O. BOX 70250, OAKLAND, CA, 94612-0250, US

(73) Assignee: iMetrikus, Inc.

(21) Appl. No.: 12/006,669

(22) Filed: Jan. 4, 2008

Related U.S. Application Data
(60) Provisional application No. 60/878,741, filed on Jan. 4, 2007.

(51) Int. Cl. G06F 17/30; G06Q 50/00

(52) U.S. Cl. 707/104.1; 705/3; 707/E17.009

(57) ABSTRACT

A central health data repository stores health data from various data providers and provides data to various data consumers. The data hub is a standardized central repository that conforms to various standards, such as Health Level Seven (HL7). The data is received according to the HL7 specification and is transmitted to the various data providers using HL7. The data may also be transmitted as a continuous data feed. In this manner, a large volume of health data may be collected, stored, and disseminated using the data hub as a standardized service. A computer system includes one or more processors, an output network interface and an input network interface, a memory for storing multiple personal health records having fields for storing data in a proprietary format or in a standard format. The memory may also include an HL7 translation module and a data insertion/retrieval code module, wherein the computer system performs as a standardized health data repository for various entities in the healthcare industry.

### CROSS-REFERENCE TO RELATED APPLICATIONS

This application claims the benefit under 35 U.S.C. §119 of Provisional Patent Application No. 60/878,741, entitled “STANDARDIZATION HEALTH DATA TRANSMISSION, RETRIEVAL AND STORAGE”, filed Jan. 4, 2007, incorporated by reference herein in it entirety.

### BACKGROUND OF THE INVENTION

1. Field of the Invention

The present invention relates to health data management computer systems. More specifically, it relates to standardized transmission, storage, and management of health-related data among multiple entities.

2. Description of the Related Art

The healthcare industry is a widespread and disparate business involving multiple entities ranging from multi-billion dollar corporations to members of a patient's family. Although the volume and nature vary widely, one aspect of the healthcare industry these parties all encounter is management of healthcare data. Companies handle data according to proprietary formats and some standardized formats while healthcare consumers at home handle the data in whatever format it is given to them and have little influence over standards and modes of transmission. To the individual, such as the grown son or daughter of an ailing parent or a home healthcare assistant, the qualitative nature and volume of the data available to them may seem overwhelming and impracticable to manage. In addition to the volume of data, the incompatible formats and timeliness of the data present problems for many types of healthcare data consumers. It would desirable for healthcare data consumers to receive such data in a standard format which that facilitates management and manipulation and receive it from a consistent, known source. Presently, there is no central, standardized data hub for receiving, storing and providing standardized healthcare data.

### SUMMARY OF THE INVENTION

One embodiment is a method of managing health-related data. Health data is received at a central data hub. The data may be received in an Health Level Seven (HL7) transmission or in a proprietary format using Web Services, TCP/IP, or FTP. If the data is not received in HL7 protocol, it is translated to HL7 protocol. The data is stored in the form of a personal health record which is capable of storing data conforming to different formats. The data is then transmitted to one or more data consumers using the HL7 specification, wherein the data hub performs as a central, standardized data hub capable of providing a continuous health data feed to data consumers.

In another embodiment, a computer system includes one or more processors, an output network interface and an input network interface, a memory for storing multiple personal health records having fields for storing data in a proprietary format or in a standard format. The memory may also include an HL7 translation module and a data insertion/retrieval code module, wherein the computer system performs as a standardized health data repository for various entities in the healthcare industry.

### BRIEF DESCRIPTION OF THE DRAWINGS

References are made to the accompanying drawings, which form a part of the description and in which are shown, by way of illustration, particular embodiments:

FIG. 1 is a network diagram showing various components in communication with a data hub in accordance with one embodiment of the present invention;

FIG. 2 is flow diagram of a process of receiving data at a data hub, storing data, and transmitting data in accordance with one embodiment of the present invention;

FIG. 3 is a flow diagram of a process of registering customers with a data hub, uploading data and transmitting data to subscribers in the form of a data feed in accordance with one embodiment;

FIG. 4 is a block diagram of a data hub in accordance with one embodiment of the present invention;

FIG. 5 is a sample format of a PHR showing that segments or portions of a PHR may store data in a proprietary or non-standard format and that other segments may store data in a standard format; and

FIGS. 6A and 6B illustrate a computer system suitable for implementing embodiments of the present invention.

### DETAILED DESCRIPTION OF THE INVENTION

Methods and systems for receiving, storing, and transmitting healthcare data among a wide range of entities and individuals are described in the various figures. Data is transmitted to a hub via a standardized transmission means, such as HL7, or by other known means in a proprietary format. Data transmitted to the hub may range from demographic data about patients, claims data, biometric data, and so on. The data is stored at the hub may be stored in a standardized format, among other formats, and may have modules for translating data from proprietary formats to a standard format for storage in the hub.

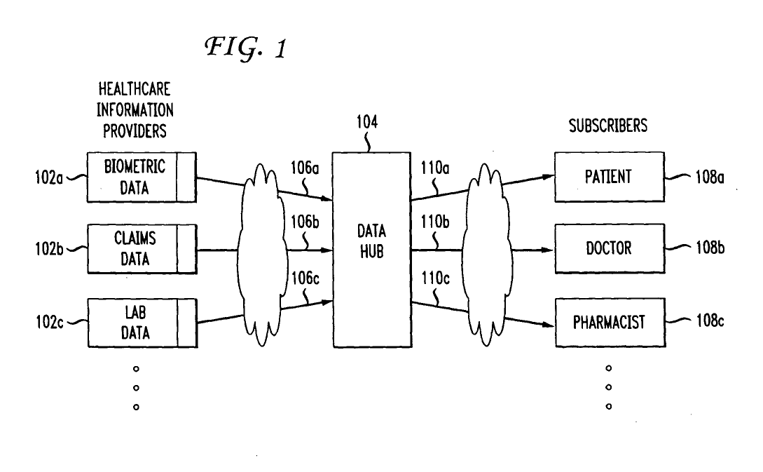

FIG. 1 is a network diagram showing various components in communication with a data hub in accordance with one embodiment of the present invention. Shown are various healthcare information providers 102a, 102b, 102c, etc. Each may have an incoming gateway server. Each is connected to a data hub 104 via connections 106a, 106b, 106c, etc. In one embodiment, these connections are made over a public network, such as the Internet. Examples of healthcare data providers include patients, doctors, clinics, insurance companies, labs, financial companies (e.g., re health savings accounts, etc.), and hospitals. Data may be transferred in a variety of modes and formats. Various methods of transferring data include Web Services, TCP/IP, and File Transfer Protocol (FTP). Health Level Seven (HL7) is another standard that may be used for the transmission of medical and health-related data. HL7 has it own standard for TCP/MLLP. Information relating to HL7 may be found at its Web site and is provided below. When transferring data from an incoming gateway server of a provider to data hub 104, data may be secured using VPN or Secure Sockets Layer (SSL).

Further details on data hub 104 are provided in FIG. 4. In one embodiment, data is stored at hub 104 in the form of a personal health record stored in a database, such as the MediCompass server from service provider, Inc. of Carlsbad, Calif. A detailed description of MediCompass is provided in pending patent application Ser. No. 10/417,794, titled Method and System for Communication and Collaboration Between a Patient and Healthcare Professional, filed Apr. 17, 2003, and assigned to service provider, Inc., which is incorporated by reference herein in its entirety and for all purposes. Pages 8 to 37 of the specification are particularly relevant to the implementation of MediCompass.

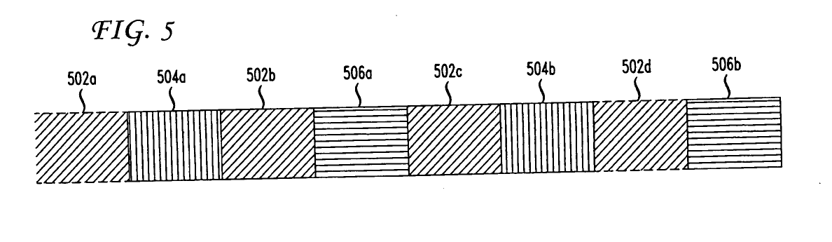

A personal health record (PHR) stores a wide variety of health information relating to one healthcare consumer. The format of the PHR may be proprietary to the operator or owner of data hub 104, but in the described embodiment, the format can accommodate storing data in certain standardized formats in addition to a proprietary format. This is shown in greater detail in FIG. 5. A patient uploading biometric data from a home health monitor using, for example, may be one of the data providers. In this scenario, the patient may use a MetrikLink device available from service provider, Inc. to transmit and upload data directly from a biometric device to data hub 104. Further details on the MetrikLink device are provided in U.S. patent application Ser. No. 09/977,472, filed Oct. 15, 2001, titled Method and Apparatus for Communicating Data Between A Medical Device and a Central Data Repository, assigned to service provider, Inc.

From data hub 104 transmits data to various types of customers 108a, 108b, 108c, and so on over communication lines 110a, 110b, and so on. In one embodiment, data transmission is over the Internet, similar to the means data is received at hub 104 from the various data providers. Examples of customers include patients, doctors, pharmacists, and other less typical healthcare data consumers, such as academic institutions (e.g. for research), financial and insurance corporations, employers, governmental agencies, non-profits, research institutions, and so on. Some of these entities do not provide data to hub 104 but rather only want to receive data. Such entities may be referred to as pay-on-demand customers of the data. For example, a university or research institute may want to receive a certain type of health-related data that is stored in a PHR for a certain demographic group. It can receive this type of anonymous data from data hub 104. In some embodiments, parties receiving data from hub 104 may have outgoing gateway servers.

Data hub 104, for example implemented as MediCompass, may be seen as a standardized data service or data broker for paying subscribers. In one embodiment, the service provides a continuous health data feed to customers who may use a reader to receive and view the data, similar to an RSS feed. In other embodiments, an entity may use data hub service to obtain a large block of data meeting certain criteria for research purposes, marketing studies, financial analysis, medical and home healthcare research, and so on. Many different types of uses are possible. The important feature is that the data is stored, received, and transmitted in one or more standardized formats so it is accessible to a wide range of users, consumers, subscribers, customers, and so on. HL7 is only one example of a well-known standard in the healthcare industry. Other standards may also be accommodated at data hub 104.

As described below, data hub 104 may receive data via HL7. For data providers who prefer to send data using this standard, the service provider (owner/operator of data hub 104) may provide a specification to those data providers that states which HL7 messages and segments are used and how they should be interpreted. A person of ordinary skill in the field having a working knowledge of HL7 would be familiar with such requirements and what information would need to be in the specification in order for a data provider to transmit data using HL7. A sample HL7 Interface Specification is provided below.

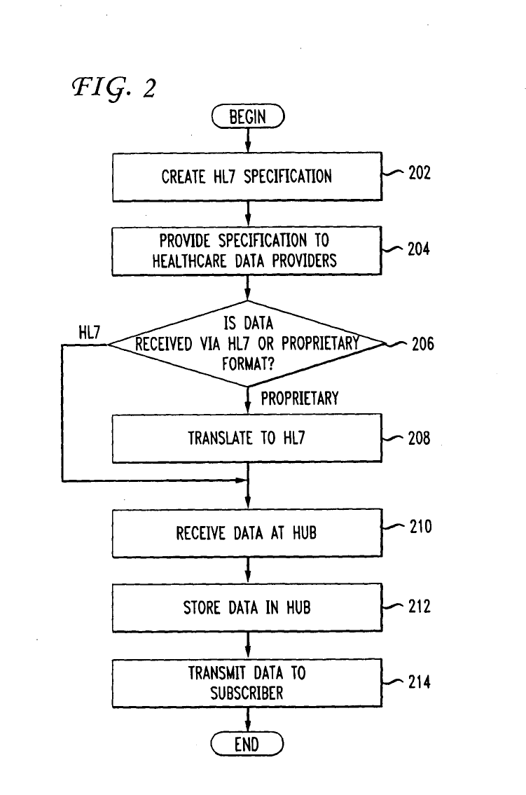

FIG. 2 is flow diagram of a process of receiving data at a data hub, storing data, and transmitting data in accordance with one embodiment of the present invention. The order of the steps provided in the flow diagram of FIG. 2 is not intended to imply a strict order of the process. Some of the steps may be done in a different order than that shown and some of the steps may not be needed in other embodiments or more steps may be needed that are not shown here. At step 202, the service provider creates an HL7 specification for use by data providers. As noted above, the specification may include which HL7 messages and segments are used and how they should be interpreted. Specifications for other standards may also be created as needed. At step 204 the specification is provided to the healthcare data providers. At step 206, a different phase of the process begins. The service provider begins receiving data from a data provider and checks whether the data is received via HL7 or in a proprietary format. In other embodiments, the service provider may also check whether the data is transmitted using other standards. HL7 is used to illustrate one embodiment of the present invention.

If the data is received in a proprietary format, which may be typical of larger entities, but not necessarily so, at step 208 the service provider performs what may be referred to as a translation or transformation of the data to HL7 at data hub 104 or at another component under control of the service provider. Methods of translating data to HL7 are known to persons skilled in the art of health data management and programming. If the data is being transmitted via HL7, control goes to step 210 where the data is received at hub 104. In other embodiments, the data may already be received at hub 104 at step 208 during the translation process. However, at step 210 the data is HL7 compliant, whereas before step 208 it may not be. At step 212 the data is stored in data hub 104, for example, in one or more PHRs in MediCompass. The data may be stored using standardized units, clinical terms conforming to Unified Code for Units of Measure UCUM, and the like, where appropriate. For example, data may be stored in a PHR in a manner that conforms to IEEE 11703 format, where an event, such as a blood glucose measurement, is recorded with a measurement value, a unit value, date/time stamp, entity identifier, and so on. Data may also be stored conforming to HIPAA. At step 214 the data may be transmitted to subscribers, customers, or other users directly from hub 104 in a standardized manner, for example, using HL7. In one embodiment, the data may be sent as a continuous feed in a syndicated health data service, at which stage the process is complete.

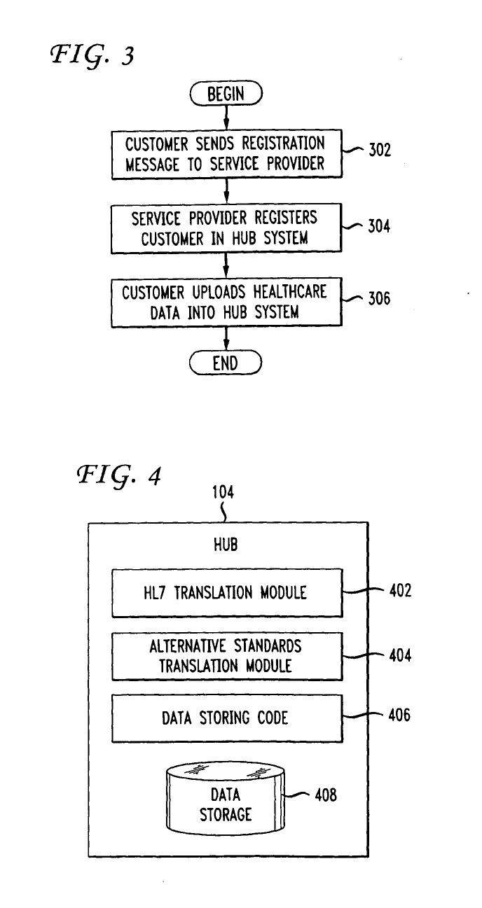

FIG. 3 is a flow diagram of a process of registering customers with a data hub, uploading data and transmitting data to subscribers in the form of a data feed in accordance with one embodiment. The order of the steps provided in the flow diagram of FIG. 2 is not intended to imply a strict order of the process. Some of the steps may be done in a different order than that shown and some of the steps may not be needed in other embodiments or more steps may be needed that are not shown here. In order for an entity, whether an individual patient or a large corporation, to upload data to data hub 104, the customer may first have to register with the service provider. At step 302 the customer or user sends a registration message to the service provider (this may be done after previous communications between the new customer and the service provider). At step 304 the service provider registers the new customer in hub 104. For example, in MediCompass, an entry for the new data provider may be created in the appropriate database. If the data provider is a patient, a PHR may be created for the patient. At step 306 the customer begins uploading healthcare data to the hub. Again, this data may come from a patient uploading biometric data from a home monitoring device or may be insurance claims data from an insurance company. In either case, in one embodiment, the entity must first register with the service provider. At this stage the customer can upload data at any time and store it in a standardized format so that other users or “data consumers” can access the data. In some scenarios the data consumers are associated with the data provider, for example a doctor, pharmacist, nurse, family member, nursing homes, and so on. In other scenarios, the data is anonymous and may be used to benefit a certain demographic of patients, such as a university or government agency doing research on heart disease or diabetes, and need volumes of accurate, standardized, and specific data related to health for their research. There are many other scenarios in which the data may be used. One of the important features of the present invention is the ability to store a wide range of health-related data in a manner that conforms to known and agreed to standards so that the data may be of benefit to numerous and disparate parties.

In one embodiment, using MediCompass and MetrikLink to illustrate, a new customer may be an individual patient who visits a pharmacy which is already registered with MediCompass. The patient receives a MetrikLink from the pharmacy and the pharmacy registers the customer with MediCompass. This may be done at the pharmacy when the customer gets the MetrikLink or at home. For example, elderly patients may prefer that the pharmacy register for them rather than having to do it themselves at home via the Internet. When the customer begins using MetrikLink at home, for example, by plugging it into a phone outlet, the biometric data is uploaded to MediCompass and may be automatically sent to the pharmacy as well and to the patient's doctor if he or she is already registered with MediCompass. Other examples include a patient visiting a doctor's office where blood work is ordered for the patient. If the lab doing the blood work is registered with MediCompass, along with the doctor and patient, the results from the tests may be stored on MediCompass (the lab is the data provider) and viewed by the patient and doctor (the data consumers), plus other entities when appropriate. In these and many other typical scenarios involving a patient, doctor, pharmacist, and lab, MediCompass becomes a standardized hub for data and MediCompass is performing a service to all the entities by receiving, storing, and transmitting health data.

FIG. 4 is a block diagram of a data hub in accordance with one embodiment of the present invention. As noted above, one example of a data hub is MediCompass from service provider, Inc., descriptions of which have been incorporated by reference and are provided below. A more generic example showing relevant components of data hub 104 are shown in FIG. 4. As described above, data providers may transmit data to data hub 104 in a proprietary format in which case data may be translated to be HL7 compliant. This may be done by HL7 translation module 402. Other standards may also be used for storing and/or transmitting the data. Alternative standards translation module 404 represents other modules, code, routines, and the like for translating data to these other standards. Given that one of the goals of the present invention is a standardized data hub which performs data services for various parties in the healthcare industry, there may be a variety of translation routines in data hub 104 to accommodate different standards that are known now—HL7 being one of the best known—to standards that may be utilized in the future or that may be more prevalent in a particular industry, such as in the financial, academic, or insurance industries. In another embodiment, all or most standards translation and interpretation services may be performed on a dedicated server in data hub 104 to reduce the processing load on the storage and management functions of hub 104.

Also included in hub 104 is code 406 for actually storing and retrieving data from a data storage area 408. Code 406 may be responsible for inserting data into, managing data, and retrieving data from PHRs. It may also be responsible for ensuring that data is stored conforming to certain standards, such as IEEE 11703, UCUM, and others, within a PHR. Data storage 408 may be any appropriate type of memory, such as a non-volatile RAM, a hard disk, and the like, suitable for storing large volumes of data. Implementations of data storage 408 are also described in the incorporated references.

FIG. 5 is a sample format of a PHR showing that segments or portions of a PHR may store data in a proprietary or non-standard format and that other segments may store data in a standard format. A PHR file format 500 has numerous fields or segments in which various types of health-related data for a single patient are stored. The fields or segments that store data in a non-standard or proprietary format are shown with diagonal lines, such as fields 502a, 502b, 502c, and 502d. This is a format created and used by the service provider, for example, service provider, to store data in a PHR and may be the most common format in the PHR by a significant percentage. Other fields in a PHR may store data according other known standards. For example, fields 504a and 504b, with the vertical lines, may store data conforming to IEEE 11703 standards. There may be fields for measurement value, unit value, date/time stamp, and so on. Fields 506a and 506b may store data conforming to standard clinical term sets. Thus, in one embodiment, a single PHR for one patient stores data conforming to various standards as needed.

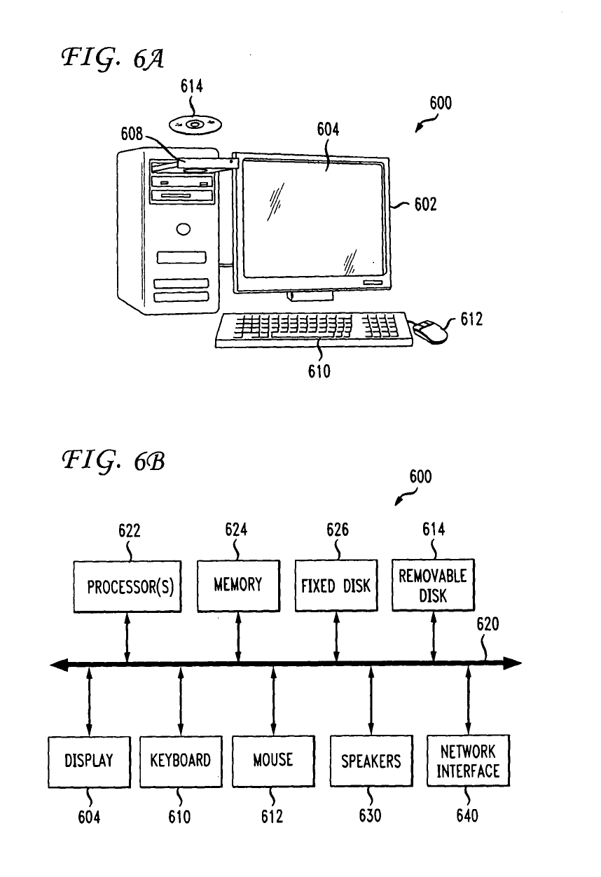

FIGS. 6A and 6B illustrate a computer system 600 suitable for implementing embodiments of the present invention. FIG. 6A shows one possible physical form of the computer system. Of course, the computer system may have many physical forms including an integrated circuit, a printed circuit board, a small handheld device (such as a mobile telephone or PDA), a personal computer or a super computer. Computer system 600 includes a monitor 602, a display 604, a housing 606, a disk drive 608, a keyboard 610 and a mouse 612. Disk 614 is a computer-readable medium used to transfer data to and from computer system 600.

FIG. 6B is an example of a block diagram for computer system 600. Attached to system bus 620 are a wide variety of subsystems. Processor(s) 622 (also referred to as central processing units, or CPUs) are coupled to storage devices including memory 624. Memory 624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 626 is also coupled bi-directionally to CPU 622; it provides additional data storage capacity and may also include any of the computer-readable media described below. Fixed disk 626 may be used to store programs, data and the like and is typically a secondary storage medium (such as a hard disk) that is slower than primary storage. It will be appreciated that the information retained within fixed disk 626, may, in appropriate cases, be incorporated in standard fashion as virtual memory in memory 624. Removable disk 614 may take the form of any of the computer-readable media described below.

CPU 622 is also coupled to a variety of input/output devices such as display 604, keyboard 610, mouse 612 and speakers 630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 622 optionally may be coupled to another computer or telecommunications network using network interface 640. With such a network interface, it is contemplated that the CPU might receive information from the network, or might output information to the network in the course of performing the above-described method steps. Furthermore, method embodiments of the present invention may execute solely upon CPU 622 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As described above, one example of data hub 104 is MediCompass. The database component of MediCompass (MC) stores various types of data. The primary data it stores are patient health data which are arranged in a PHR. An MC-Database receives data from MetrikLink via a telephone line or via a computer. When a patient logs in on the MC-Patient Web site, MC-Database serves an HTML page to the patient's PC. The HTML page may contain data in the form of text and graphs generated from graphing software at the MC-Database servers. The data on the page are generated using an Ajax engine (a software tool used in software development) and are based on patient or doctor preferences. A patient sees a “Dashboard,” which contains a number of Web parts. A Web part, seen by a user essentially as a miniature, window-type display area (see figures below), downloads and updates the information displayed in the Web part. The computer on which a doctor views the MC-Doctor Web site may receive plug-ins from MC-Database to enable browser functionality. In a previous version of MC-Database, ActiveX controls may also be hosted on the PC browser in certain graph views.

MC-Patient functionality is accessible through an MC-Patient Web site. A patient logs onto the Web site and has access to one or more Dashboards, which provide an overview of the patient's PHR and consists of a number of menus and Web parts. The menus and Web parts available to each patient are predetermined by program or domain administrator (a non-service provider employee, typically from a healthcare entity, such as a medical group or health maintenance organization), who sets up the Dashboard for an entire group of patients, for example, those who belong to a particular HMO. Each patient in the same domain has access to the same default screens in the Dashboards. A doctor cannot modify Dashboards of a patient or for a group of patients. The program or domain administrator can allow patients to remove a Web part from the patient's Dashboard. For example, a patient may not wish to see a “Weight and BMI” Web part in the patient's Dashboards.

Once in a Dashboard, a patient may perform various activities, including reading messages from his or her doctor, uploading biometric data from a monitoring device, adding information such as medications taken, exercise history, and stress levels. Whether the patient adds any information is up to the patient. A patient may enter information as frequently or as infrequently as desired. The Web site has a Web part referred to as Message Center that stores messages in text form only.

The MC-Patient Web site displays data to a user, using Dashboards and Web parts, in plain text or through various graphical displays, such as charts. The graphical representations are created at MC-Database by a graphing software component.

The number of reports and graphs a single patient may see depends on the healthcare needs of the patient. For example, about 56 reports and graphs are available for an individual monitoring for diabetes and about 26 for patients with HIV. Some reports and charts simply list or provide a graphical display of the information sent by the patient. Others include statistical values calculated by MC-Database, such as averages, maximums, standard deviations, and so on.

The MC-Patient Web site displays links to other Web sites for additional information on a health-related topic. For example, a patient with diabetes may see links to specific resources and guidelines available to the patient such as links to the American Diabetes Association or Diabetes UK Web sites. The links a patient sees depend on the patient's health care needs and are determined in consultation with the healthcare organization during a program implementation.

Links displayed in a patient's Dashboard are for external content (not produced or stored by service provider), are educational and informational in nature, and may not change over the course of the MediCompass service. External content may change, as the service provider exerts no control over the content providers. Although the service provider does not typically produce, create, or store any original educational or informational content, patients can select external content using links on the MC-Patient Web site to educate themselves on a health-related topic. Some service provider programs may provide content for the system to present to the users of the system. MediCompass does not select external educational programs or any portions of an educational program for a patient based on the data the patient submits.

Presently, MC-Patient and MC-Database have limited functionality regarding treatment programs and instructions to patients. A doctor can examine patient data in reports, such as the Glucose logbook via the MC-Doctor Web site, and can determine whether the patient is compliant with the treatment plan or adjustments to the plan. However, MC-Patient alone does not generate compliance data, nor does it analyze or examine patient data to encourage a patient to follow a treatment program or take other action. MC-Patient and MC-Database do not prompt or remind patients to follow a treatment program or take any health-related actions. Nor do they provide health-related instructions based on patient data stored in a PHR in MC-Database.

The MC-Patient Web site may offer a patient links to external Web sites where a patient can take a specialized survey referred to as a health-risk assessment. In a previous version, a doctor may send a standardized health survey, for example, about shortness of breath, to gather information for clinical trials. The questions or queries in the standardized survey were selected by an external organization. To initiate the survey, the doctor selected standardized queries that were sent to patients using the MC-Patient Web site in an email with a link or URL to the Web site providing the survey. Responses to the queries were stored in MC-Database and could be downloaded by the doctor.

MC-Patient supports communication among patients using the Web site. Specifically, the Web site enables Web parts that function as bulletin boards and enable chat sessions between patients. Some of these are hosted by doctors or other healthcare professionals.

MC-Pro allows doctors to view data relating to a patient or a group of patients using the MC-Pro Web site. For example, a doctor can view patient group data in a graphical representation. A doctor having a group of patients with the same health condition can view the following types of reports and graphical representations: Population Detail, Population Indicator, and Population Summary Reports.

MC-Pro allows a doctor to generate aggregate reporting for their patient population. MC-Professional has an “Analyze” tool which provides functionality for aggregate reporting that enables a doctor to examine data for all the doctor's patients who are also using MediCompass. For example, a doctor can determine how many patients meet a medical diagnosis, thereby allowing the doctor to determine whether he or she is meeting a specific standard of care. A doctor may set up threshold alert values of biometric readings for patients and be alerted to readings of specific patients by having a red flag or icon next to the patient's name in the MC-Doctor Web site. A doctor may determine which patients have not uploaded data in a pre-selected number of days. For example, the Upload Inactivity Report lists names and information about all patients who have not uploaded for thirty days. MC-Pro contains many reports of this type and new reports are continually added according to our product roadmap. However, the data in such reports are not displayed or available in graph form, such as a chart showing patients as data points, where each data point, for example, indicates a calculated biometric measurement value and a time period since the last upload.

As with MC-Patient, MC-Pro allows doctors to access external Web sites via URLs displayed in the appropriate Web part. A doctor may use “Message Center” of the MC-Pro Web site to send information on relevant external links to patients. The doctor may send an e-mail message containing a URL using MC-Pro and MediCompass Mobile to one or more patients. For example, a doctor may send a patient a message with the Web site address of the external content (the patient reads the message in the patient's Message Center). Messages are text only; thus, a patient needs to “cut and paste” the Web site address (URL) to a Web browser address box to access the external site. Given that the messages are textual and not HTML links, a patient cannot access the external content by clicking on or through the Web site address in the message and linking to the Web site.

The messages a doctor sends through Message Center are created solely by a doctor and can only be viewed in Message Center. A doctor may manually type a message in text form or select a message from a list of standard messages. Message Center does not currently allow the doctor to attach a file (such as a PDF or Word document) to the message.

MC-Pro includes a report that allows a doctor to track a patient's compliance with a treatment program and see how well a patient is adhering to health instructions. For example, a patient is instructed to follow a treatment program for a health condition that requires five readings a week using a remote monitoring device and 30 minutes of exercise each day. The doctor can access the patient's logbook to see how many readings a day and how much exercise the patient has logged, and use his or her professional judgment, without encouragement or suggestions from MC-Pro or any other source, as to whether to send the patient a message.

In some versions of MediCompass, MC-Database automatically sends alerts and reminders to users in the form of an e-mail based on criteria set by the doctor, such as frequency and content.

Below is one embodiment of a sample HL7 Interface Specification for use with data hub 104 implemented as MediCompass (with MetrikLink and another sample device referred to as AirWatch; other devices are listed in the portion below labeled Appendix B, which is included herein) and various data providers, also referred to as “Trading Partner” or Vendor below. A section listed as Appendix A, also included herein provided HL7 segment information.

### 1 Overview

This portion of the patent outlines HL7 interface interaction. There are four types of data which the service provider system can accommodate:
Patient information which consists of registering patients and assigning devices to patients.
Patient information updates such as: changes to demographics.
Patient information updates such as: replacing a device, assigning a second device to the patient, or deactivating a patient.
Readings from medical devices uploaded to the MediCompass database via MediCompass Connect or by MediCompass Web Application.
The Four message types that the service provider system implements are:
   ADT˜A04
   ADT˜A08
   ADT˜A03
   ORU˜R01
The current supported version of HL7 implemented by the service provider is 2.4.

### 2 HL7 Message Exchanges

When service provider enters into partnership with Trading Partner, HL7 message data is exchanged between two systems. service provider receives HL7 messages ADT 04, 03, 08 and Acks for ORU R01 from Trading Partner and service provider will be sending HL7 message ORU R01 and Acks for ADT 04, 03, 08 to Trading Partner.
   3 HL7 messages

### 3.1 ADT˜A04—Register A Patient or a Patient to a Device

The ADT˜A04 message is used to register a patient, register a patient/device(s) combination. The patient could be a new patient who has not been registered before, or a patient which was previously registered and then deactivated. A patient is never deleted from the system, but can be deactivated and then reactivated. A device is only registered to one person at a given time.

NOTE: It is possible to register a patient without an accompanying device, and send the corresponding device(s) registration message at a later date/time

The following HL7 segments are required for a valid ADT˜A04 message:

### MSH—Message Header

### EVN—Event Type

### PID—Patient Identification

### PV1—Patient Visit

The contents of the fields will be negotiated between service provider and the Vendor. The event type code indicates the action the Vendor is initiating, rather than inferring the action from the message.

### 3.1.1 Segment EVN Event Type:

Field EVN-1 Event Type Code can have following values:
PA—Patient Add with no device information
PAD—Patient Add with 1 or more devices
DA—Device Add only

### 3.1.2 Segment PID Patient Identification:

Field PID-3 Patient Identifier List is a CX data type. The required components are: ID (ST) and Identifier Type Code (ID) and optional component Assigning Authority (HD). The field PID-3 Patient identifier list is a repeatable field.
The component Identifier Type code (ID) can have the following values:
   PC—Patient ID (required)
   UT—User Type (required) valid values are MC or NONMC.
   PR—Practice ID (required) (int)
   SN—Device Serial Number (required for Event Type Code: DA & PAD)
   UN—User Name(optional) (required for User Type:MC)
   PW—Password(optional) (required for User Type:MC)
   EA—email address (optional)
   CO—Condition (optional) (repeatable) (valid conditions: Asthma, Diabetes, Cardiovascular and My Records) (used only for Event Type Code:PA or PAD)
   Types Codes UN, PW are needed for registering Patient to login into MediCompass web application.
      Component ID (ST) will hold corresponding value based on Identifier Type Code used.
      Optional Component Assigning Authority (HD) is used along with Type Code SN for device type name like eg: METRIKLINK, refer to Appendix B—Devices for complete list supported.
         Field PID-5 Patient Name (XPN) is used to receive patient name. (required)
         Field PID-7 Date of birth (TS) is optional.
         Field PID-8 Administrative Sex is optional.
         Filed PID-11 Patient Address (XAD) (optional) demographic details
         Filed PID-12 Patient Address—Country Code (optional) (valid values are US or UK).

### 3.1.3 Segment PV1 Patient Visit:

Field Patient Class is set to 0 (out patient).

### 3.1.4 Sample A04 Messages

3.1.4.1 Registration Message with only Patient data (Event code PA):

MSH|\hat{ }~\&| SENDING APPLICATION|SENDING FACILITY|RECEIVING
APPLICATION|RECEIVING
FACILITY|20060731130114||ADT\hat{ }A04|1017205|P|2.4
EVN|PA|20060731080052
PID|1||1234567\hat{ }\hat{ }\hat{ }\hat{ }PC~MC\hat{ }\hat{ }\hat{ }\hat{ }UT~PRACTICE1\hat{ }\hat{ }\hat{ }\hat{ }PR~TOM123\hat{ }\hat{ }\hat{ }\hat{ }UN~HAS
HPASSWORD\hat{ }\hat{ }\hat{ }\hat{ }PW~TOM@ABC.COM\hat{ }\hat{ }\hat{ }\hat{ }EA~ASTHMA\hat{ }\hat{ }\hat{ }\hat{ }CO||JR\hat{ }TOM\hat{ }
PLUMMER||19480203|M|||254 E238ST\hat{ }\hat{ }EUCLID\hat{ }OH\hat{ }44123|US
PV1|1|O

3.1.4.2 Registration Message with only Device(s) data (Event code DA):

MSH|\hat{ }~\&| SENDING APPLICATION|SENDING FACILITY|RECEIVING
APPLICATION|RECEIVING
FACILITY|20060731130114||ADT\hat{ }A04|1017206|P|2.4
EVN|DA|20060731080052
PID|1||1234567\hat{ }\hat{ }\hat{ }\hat{ }PC~MC\hat{ }\hat{ }\hat{ }\hat{ }UT~PRACTICE1\hat{ }\hat{ }\hat{ }\hat{ }PR~DEVICE SERIAL
1\hat{ }\hat{ }\hat{ }METRIKLINK\hat{ }SN~DEVICE SERIAL
2\hat{ }\hat{ }\hat{ }METRIKLINK\hat{ }SN||JR\hat{ }TOM\hat{ }PLUMMER
PV1|0|O

3.1.4.3 Registration Message with Patient and Device(s) (Event code PAD):

MSH|\hat{ }~\&|SENDING APPLICATION|SENDING FACILITY|RECEIVING
APPLICATION|RECEIVING
FACILITY|20060731130114||ADT\hat{ }A04|1017207|P|2.4
EVN|PAD|20060731080052
PID|1||1234567\hat{ }\hat{ }\hat{ }\hat{ }PC~MC\hat{ }\hat{ }\hat{ }\hat{ }UT~PRACTICE1\hat{ }\hat{ }\hat{ }\hat{ }PR~DEVICE
SERIAL\hat{ }\hat{ }\hat{ }METRIKLINK\hat{ }SN~TOM123\hat{ }\hat{ }\hat{ }\hat{ }UN~HASHPASSWORD\hat{ }\hat{ }\hat{ }\hat{ }PW~T
OM@ABC.COM\hat{ }\hat{ }\hat{ }\hat{ }EA~ASTHMA\hat{ }\hat{ }\hat{ }\hat{ }CO||JR\hat{ }TOM\hat{ }PLUMMER||19480203||M|||
254 E238ST\hat{ }\hat{ }EUCLID\hat{ }OH\hat{ }44123|US
PV1|0|O

### 3.2 ADT˜A03—Deactivate Patients/Devices or Deactivate a Patient

The ADT˜A03 message is used to remove a patient from the system, or deactivate a device from a patient. Patients can be deactivated for various reasons including changing health providers or changing enrollment eligibility in a program using MediCompass technology. When a patient is deactivated using an AirWatch, this medical device cannot be reissued to a new patient as it is a FDA cleared as a single user device. A MetrikLink can be reissued. NOTE: It is possible to deactivate a device without deactivating a patient, and send the corresponding patient deactivate message at a later date/time. It is also possible to deactivate a person with activated devices, causing all activated devices to be deactivated.

The following HL7 segments are required for a valid ADT˜A03 message:

### MSH—Message Header

### EVN—Event Type

### PID—Patient Identification

### PV1—Patient Visit

### 3.2.1 Segment EVN Event Type:

Field EVN-1 Event Type Code can have following values:
PD—Patient Delete (deactivates Patient and all devices)
DD—Device Delete (deactivates all devices in the message for the specified patient)
DAD—Delete All Devices(deactivates all devices for patient)

### 3.2.2 Segment PID Patient Identification:

Field PID-3 Patient Identifier List is a CX data type. The required components are: ID (ST) and Identifier Type Code (ID). The field patient id list is a repeatable field.

The component Identifier Type code (ID) can have the following values:
PC—Patient ID (required)
UT—User Type (required) valid values are MC or NONMC.
PR—Practice ID (required)
SN—Device Serial Number (required for Event Type Code: DD)
   Component ID (ST) will hold corresponding value based on Identifier Type Code used.
   Optional Component Assigning Authority (HD) is used along with Type Code SN for Device Type Name like eg: METRIKLINK, refer to Appendix B—Devices for complete list supported.

Field PID-5 Patient Name (XPN) is used to receive patient name. (Required)

### 3.2.3 Sample A03 Messages

### 3.2.3.1 Example Patient De-Activation Message (Type Code PD):

MSH|\hat{ }~\&|SENDING APPLICATION|SENDING FACILITY|RECEIVING
APPLICATION|RECEIVING FACILITY|20060801082647||ADT\hat{ }A03|CONTROL
ID|P|2.4
EVN|PD|20050801082837
PID|1||12345\hat{ }\hat{ }\hat{ }\hat{ }PC~MC\hat{ }\hat{ }\hat{ }\hat{ }UT~PRACTICE1\hat{ }\hat{ }\hat{ }\hat{ }PR||PLUMMER\hat{ }TOM
PV1|1|O

### 3.2.3.2 Example Device De-Activation Message (Type Code DD):

MSH|\hat{ }~\&|SENDING APPLICATION|SENDING
FACILITY|RECEIVING
APPLICATION|RECEIVING
FACILITY|20060801082647||ADT\hat{ }A03|CONTROL
ID|P|2.4
EVN|DD|20050801082837
PID|1||12345\hat{ }\hat{ }\hat{ }\hat{ }PC~MC\hat{ }\hat{ }\hat{ }\hat{ }UT~PRACTICE1\hat{ }\hat{ }\hat{ }\hat{ }-
PR~DEVICE
SERIAL1\hat{ }\hat{ }\hat{ }METRIKLINK\hat{ }SN~DEVICE
SERIAL2\hat{ }\hat{ }\hat{ }METRIKLINK\hat{ }SN
||PLUMMER\hat{ }TOM
PV1|1|O

### 3.2.3.3 Example Patient De-Activation Message (Type Code DAD):

MSH|\hat{ }~\&|SENDING APPLICATION|SENDING FACILITY|RECEIVING
APPLICATION|RECEIVING FACILITY|20060801082647||ADT\hat{ }A03|CONTROL
ID|P|2.4
EVN|DAD|20050801082837
PID|1||12345\hat{ }\hat{ }\hat{ }\hat{ }PC~MC\hat{ }\hat{ }\hat{ }\hat{ }UT~PRACTICE1\hat{ }\hat{ }\hat{ }\hat{ }PR||PLUMMER\hat{ }TOM
PV1|1|O

### 3.3 ADT˜A08—Update Patient Information

The ADT˜A08 message is used to update the patient information. The patient information that can be updated using ADT˜A08 could be any personal information of a patient that already exists in the system like password, name, address or email.

The following HL7 segments are required for a valid ADT˜A08 message:

### MSH—Message Header

### EVN—Event Type

### PID—Patient Identification

### PV1—Patient Visit

### 3.3.1 Segment EVN Event Type:

Field EVN˜1 Event Type Code can have following values:
P1—Patient Personal Information Change
PCW—Password Change

### 3.3.2 Segment PID Patient Identification:

Field PID-3 Patient Identifier List is a CX data type. The required components are: ID (ST) and Identifier Type Code (ID). The field patient id list is a repeatable field.
The component Identifier Type code (ID) can have the following values:
   PC—Patient ID (required)
   UT—User Type (required) valid values are MC or NONMC.
   PR—Practice ID (required)
   UN—User Name(optional)
   PW—Password(required only for Event Code PCW)
   EA—email address (optional)
Types Codes UN and PW are needed for registered Patient to login into Medical Compass web application.
   Component ID (ST) will hold corresponding value based on Identifier Type Code used.
      Field PID-5 Patient Name (XPN) is used to receive patient name. (required)
      Field PID-7 Date of birth (TS) is optional.
      Field PID-8 Administrative Sex is optional.
      Filed PID-11 Patient Address (XAD) (optional) demographic details

### 3.3.3 Segment PV1 Patient Visit:

Field Patient Class is set to 0 (out patient).

### 3.3.4 Sample A08 Messages

3.3.4.1 Updates Patient Personal information only (Event code PI):

MSH|\hat{ }~\&| SENDING APPLICATION|SENDING FACILITY|RECEIVING
APPLICATION|RECEIVING
FACILITY|20060731130114||ADT\hat{ }A08|1017205|P|2.4
EVN|PI|20060731080052
PID|1||1234567\hat{ }\hat{ }\hat{ }\hat{ }PC~MC\hat{ }\hat{ }\hat{ }\hat{ }UT~PRACTICE1\hat{ }\hat{ }\hat{ }\hat{ }PR~TOM123\hat{ }\hat{ }\hat{ }\hat{ }UN~TOM
@ABC.COM\hat{ }\hat{ }\hat{ }\hat{ }EA~ASTHMA\hat{ }\hat{ }\hat{ }\hat{ }CO||JR\hat{ }TOM\hat{ }PLUMMER||19480203|M|||254
E238ST\hat{ }\hat{ }EUCLID\hat{ }OH\hat{ }44123|US
PV1|1|O

3.3.4.2 Updates Patient Password only (Event code PCW):

MSH|\hat{ }~\&| SENDING APPLICATION|SENDING FACILITY|RECEIVING
APPLICATION|RECEIVING
FACILITY|20060731130114||ADT\hat{ }A08|1017205|P|2.4
EVN|PCW|20060731080052
PID|1||1234567\hat{ }\hat{ }\hat{ }\hat{ }PC~MC\hat{ }\hat{ }\hat{ }\hat{ }UT~PRACTICE1\hat{ }\hat{ }\hat{ }\hat{ }PR~HASHPASSWORD\hat{ }\hat{ }\hat{ }\hat{ }
PW||JR\hat{ }TOM\hat{ }PLUMMER
PV1|1|O

### 3.4 ORU˜R01—ORU Subscription

The ORU˜R01 message is used to send patient readings such as blood pressure, blood glucose, or scale readings. The message could have multiple events represented by multiple OBC segments and multiple readings represented by multiple OBX segments.

The following HL7 segments are required for a valid ORUR01 message:

### MSH—Message Header

### PID—Patient Identification

ORC—Common Order
   OBR—Observation Request
      OBX—Observation/result

### 3.4.1 Segment PID Patient Identification:

Field PID-3 Patient Identifier List is a CX data type. The required components are: ID (ST) and Identifier Type Code (ID). The field patient id list is a repeatable field.
The component Identifier Type code (ID) can have the following values:
   PC—Patient ID (required)
   PR—Practice ID (required)
   SN—Device Serial Number (required)
   SR—Source for data (required) (Valid values: WEB,UPLOAD)
      Component ID (ST) will hold corresponding value based on Identifier Type Code used. Component Assigning Authority (HD) is used along with Type Code SN for Device Type name like eg: METRIKLINK.

Field PID-5 Patient Name (XPN) is used to receive patient name. (required)

### 3.4.2 Segment ORC Common Order:

ORC segment is made into group array to hold multiple events in message.

Field Order Control (ID) (required) is sequence of event.

The ORC group will contain one or more OBR groups.

### 3.4.3 Segment OBR Observation Request:

Field Set ID (ID) will hold the sequence number of the Event message within the current ORC container group.

Field OBR-4 Universal Service Identifier:

Component Text (ST) will hold the Event type for the following readings that are being sent in the OBX segments. Each OBR group will contain one or more OBX segments.

### 3.4.4 Segment OBX Observation/Result:

OBX segment is made into a group array to hold multiple reading in a single event.

Each reading will have at least one OBX segment in the ORU message.
Field OBX 1 Set Id (ID) is the index of the OBX segment starting from 1.
Field OBX 3 Observation Identifier is a CE data type. The first component Identifier is used please refer below table for details.
Field OBX 5 Observation Value has the result of the reading. For blood glucose readings that are either high or low according to the device settings, the character strings ‘High’ or ‘Low’ are used in lieu of a numerical reading.
Field OBX-6 Units is a CE data type. Only the second component is used please refer below table for details.
Field OBX-11 Observation Result Status should have an “F” for final.
Field OBX-14 Date/time of the Observation has the date and time that the reading was taken. The format is YYYYMMDDHHMMSS.
Three types are data are not available for transmission via the HL7 interface:
   Observations that have a observation date/time in the future
   Observations that do not have a valid data
   Blood Glucose Control Readings

Data for Component Identifier (ST) under field OBX-3 observation identifier (CE) and component Text (ST) under field OBX-6 Unit (CE).

| Identifier | Text | Units | Events Type |
|---|---|---|---|
| 1001 | Blood glucose | mg/dl | Blood Glucose |
| 1002 | Blood pressure diastolic | mmHg | Blood Pressure |
| 1003 | Blood pressure systolic | mmHg | Blood Pressure |
| 1004 | Blood pressure pulse | beats/min | Blood Pressure |
| 1005 | Blood oxygen | % | |
| 1006 | Blood oxygen pulse | beats/min | |
| 1007 | Peak flow | L/min | |
| 1008 | Weight | Pounds | Weight |
| 1009 | Height | ″ | Weight |
| 1010 | Temperature | Fahrenheit | Temperature |
| 1011 | Timeslot | N/A See notes | Blood Glucose, |
| | | | Meal |
| 1012 | PEF Code | Liters | Asthma |
| 1013 | FEV1 Code | Liters | Asthma |
| 1014 | Short Effort Code | Y/N | Asthma |
| 1015 | Cough Code | Y/N | Asthma |
| 1016 | Personal Best PEF Code | Liters | Asthma |
| 1017 | Post Medication Code | Y/N | Asthma |
| 1018 | Long Time To Peak | Y/N | Asthma |
| | Code | | |
| 1019 | PEFLimit1 Code | Liters | Asthma |
| 1020 | PEFLimit2 Code | Liters | Asthma |
| 1021 | PEFLimit3 Code | Liters | Asthma |
| 1022 | StartTime | DateTime | Basal Temporary |
| 1023 | Percentage | % | Basal Temporary |
| 1024 | DurationTotalMinutes | Mins | Basal Temporary |
| 1025 | MealType | N/A See notes | Macronutrient |
| 1026 | MealSize | N/A | Macronutrient, |
| | | | Meal |
| 1027 | Calories | cal | Macronutrient |
| 1028 | Fats | g | Macronutrient |
| 1029 | Carbohydrates | g | Macronutrient |
| 1030 | Proteins | g | Macronutrient |
| 1031 | Meal Comments | N/A See notes | Macronutrient, |
| | | | Meal |

Notes:
For Identifier 1011 (Timeslot)
Valid values are below

| | |
|---|---|
| Time Slot ID | Description |
| 1 | Before breakfast |
| 3 | After breakfast |
| 5 | Before lunch |
| 7 | After lunch |
| 9 | Before dinner |
| 11 | After dinner |
| 14 | Bedtime |
| 15 | Night |
| 101 | Before Meal |
| 102 | After Meal |

For Identifier 1025 (MealType)
Valid values are below

| | |
|---|---|
| Meal Type ID | Description |
| 1 | Breakfast |
| 2 | Lunch |
| 3 | Dinner |
| 4 | Bedtime Snack |
| 5 | Snack |
| 6 | Snack - Low Sugar |
| 1 | Breakfast |
| 2 | Lunch |

For Identifier 1031 (MealComment)
Valid values are below

| | |
|---|---|
| Meal Comments ID | Comment Text |
| 101 | Not Enough Food |
| 102 | Too Much Food |
| 103 | Mild Exercise |
| 104 | Hard Exercise |
| 105 | Medication |
| 106 | Stress |
| 107 | Illness |
| 108 | Feel Hypo |
| 109 | Menses |
| 110 | Vacation |
| 111 | Other |

### 3.4.5 Example Observation Message:

MSH|\hat{ }~\&|SENDING APPLICATION|SENDING
FACILITY|RECEIVING APPLICATION|RECEIVING
FACILITY|20061010085920||ORU\hat{ }R01|10353|P|2.4
PID|||2000001\hat{ }\hat{ }\hat{ }\hat{ }PC~DEVICE
SERIAL\hat{ }\hat{ }\hat{ }METRIKLINK\hat{ }SN~WEB\hat{ }\hat{ }\hat{ }\hat{ }SR||PLUMMER\hat{ }TOM
ORC|1
OBR|1|||BLOOD GLUCOSE
OBX|1||1001||7.22222222222222|\hat{ }MG/DL|||||F|||20070105123917
OBX|2||1011||102|\hat{ }N/A|||||F|||20070105032830
OBX|3||1031||109|\hat{ }N/A|||||F|||20070105032830
ORC|2
OBR|2|||BLOOD PRESSURE
OBX|1||1002||49.000|\hat{ }mmHG|||||F|||20070105123920
OBX|2||1003||101.000|\hat{ }mmHG|||||F|||20070105123922
OBX|3||1004||60|\hat{ }beats/min|||||F|||20070105123924
ORC|3
OBR|3|||ASTHMA
OBX|1||1012||326.00|\hat{ }Liters|||||F|||20070128183414
OBX|2||1013||2.10|\hat{ }Liters|||||F|||20070128183425
OBX|3||1014||0|\hat{ }Y|||||F|||20070128183442
OBX|4||1015||0|\hat{ }Y|||||F|||20070128183500
OBX|5||1016||500.0|\hat{ }Liters|||||F|||20070128183537
OBX|6||1017||0|\hat{ }Y|||||F|||20070128183539
OBX|7||1018||0|\hat{ }Y|||||F|||20070128183541
OBX|8||1019||0|\hat{ }Liters|||||F|||20070128183542
OBX|9||1020||0|\hat{ }Liters|||||F|||20070128183543
OBX|10||1021||0|\hat{ }Liters|||||F|||20070128183545

### 3.5 ACK—Acknowledgment

Each message sent requires an acknowledgement message in reply. If an acknowledgement is not received within pre-set time period then the message is retransmitted until an acknowledgement is received or a pre-defined number of retransmissions have occurred. If the number of retransmissions has been exhausted, the message is suspended in the MediCompass system until such time as action is taken by administrative personnel.

The following HL7 segments are required for a valid ACK message:

### MSH—Message Header

### MSA—Message Acknowledgment

### ERR—Error

### 3.5.1 Segment MSA

Field MSA-1AcknowledgmentCode will have AA for Application Accept, AR for Application Reject or AE for Application Error.

Field MSA-2 MessageControlId will be populated with control number of Original message.

Field MSA-6 ErrorCondition

For Success, Component IdentifierId will be populated with “Success”

For Failure, Component IdentifierId will be populated with “Errors”

### 3.5.2 Segment ERR

This segment is generated only in case of error condition.

Field ERR-1 ErrorCodeAndLocation(ELD) is repeating field for each error raised while processing.
Component CodeIdentifyingError (CE) has below two sub components
   IdentifierId(ST) which will hold Error Code
   Text(ST) which will Error Text

Below is Table Error code and text

| Error | |
|---|---|
| code | Error text |
| 103 | Can't unregister/register device. Device is registered to other |
| | person. |
| 101 | The record with the same control was already processed! |
| 1001 | Invalid MSH 3 (sending application) field. |
| 1002 | Invalid MSH 4 (sending facility) field. |
| 1003 | Invalid MSH 5 (receiving application) field. |
| 1004 | Invalid MSH 6 (receiving facility) field. |
| 1005 | Sending App is Null |
| 1006 | Sending Facility is Null |
| 1007 | Receiving App is Null |
| 1008 | Receiving Facility is Null |
| 1009 | Control id is Null |
| 1010 | Receiving App is must be Service provider |
| 1011 | Receiving Facility must be Service provider |
| 1012 | Practice ID is Null |
| 1013 | Invalid Practice ID |
| 1014 | User Type is Null |
| 1015 | Application Error: Can not load patient\Can not update patient\Can |
| | not remove patient/Can not register device(s)\Username XXXX is |
| | In Use/Device is already registered to same person and it is active/ |
| | Patient is already Inactivate. |
| 1016 | AuthenticationError |
| 1017 | Patient not found |
| 1018 | Device not found |
| 1019 | PatientAlreadyExists |
| 1020 | Patient belongs to different facility |
| 1021 | Null Patient Id |
| 1022 | Invalid User Type |
| 1023 | Invalid Event Type Code Field |
| 1024 | Valid Password required for a Medicompass User |
| 1025 | Valid User Name required for a Medicompass User |
| 1026 | Password Change is not a valid action for NONMEDICOMPASS |
| | user |
| 1027 | Patient is Added Successfully but some of the condition values are |
| | invalid |
| 1028 | Patient belongs to different facility. |
| 1029 | Invalid Country Code |
| 1030 | Patient is in Inactive state no action can be performed. |
| 1031 | Devices must be present in the message for this kind of action |
| | code. |
| 1032 | One or more of the devices sent are invalid. |
| 1033 | Patient has been added but there are no devices present in the |
| | message. |
| 1034 | Non Medicompass User with USER NAME/Password Field can |
| | not be processed. |
| 1035 | Non Medicompass User with Password Field can not be processed. |
| 1036 | User Name Change is not a valid action for Non Medicompass |
| | User. |

### 3.5.3 Sample Messages Acknowledgment

3.5.3.1 Example Acknowledgement Message with Success

MSH|\hat{ }~\&|SENDING APPLICATION|SENDING
FACILITY|RECEIVING
APPLICATION|RECEIVING
FACILITY|20060111165729.0000-0500||
ACK\hat{ }A04|1|P|2.4
MSA|AA|1||||Success

3.5.3.2 Example Acknowledgement Message with Error text and code

MSH|\hat{ }~\&|SENDING APPLICATION|SENDING FACILITY|RECEIVING
APPLICATION|RECEIVING FACILITY|20061004133054-
0400||ACK\hat{ }A04|97|P|2.4
MSA|AR|97||||ERRORS
ERR|\hat{ }\hat{ }\hat{ }103&DEVICE REGISTERED TO OTHER PATIENT~\hat{ }\hat{ }\hat{ }1001&INVALID
MSH 3 (SENDING APPLICATION) FIELD.

### APPENDIX A

### HL7 Segments

### 4 MSH—Message Header

| | | Data | | |
|---|---|---|---|---|
| | Name | type | Required | Example |
| 1 | Field separator | ST | Yes | Dynamic |
| 2 | Encoding characters | ST | Yes | Dynamic |
| 3 | Sending application | HD | Yes | See Notes |
| 4 | Sending facility | HD | Yes | See Notes |
| 5 | Receiving application | HD | Yes | See Notes |
| 6 | Receiving facility | HD | Yes | See Notes |
| 7 | Date/time of message | TS | Yes | See Notes |
| 8 | Security | ST | No | |
| 9 | Message type | MSG | Yes | HL7 2.4 |
| 10 | Message control Id | ST | Yes | Unique # |
| 11 | Processing Id | PT | Yes | T or P |
| 12 | Version Id | VID | Yes | 2.4 |
| 13 | Sequence number | NM | No | |
| 14 | Continuation pointer | ST | No | |
| 15 | Accept acknowledgment type | ID | Yes | AL |
| 16 | Application acknowledgment type | ID | Yes | AL |
| 17 | Country code | ID | No | |
| 18 | Character set | ID | No | |
| 19 | Principal language of message | CE | No | |
| 20 | Alternate char set handling scheme | ID | No | |
| 21 | Message profile identifier | EI | No | |

Notes:
1) Fields 3, 4, 5, and 6 of the MSH segment are HD data type which
has three subfields:
Namespace ID
Universal ID
Universal ID Type
The contents of the fields will be negotiated between service provider
and the Vendor. Each vendor will have a unique HD data type for sending
and receiving.
2) Field 7, Date/time of message is in the format YYYYMMDDHHMMSS
3) Field 10, Message control Id is a unique number. It is usually the date,
time and the message.
4) Field 11, Processing Id is either a T for test patients or P for production.

### 4.1 EVN—Event

| | | Data | | |
|---|---|---|---|---|
| | Name | type | Required | Example |
| 1 | Event Type Code | ST | Yes | See Notes |
| 2 | Date/time of event | TS | Yes | Dynamic |

### 4.2 PID—Patient Identification

| | | Data | | |
|---|---|---|---|---|
| | Name | type | Required | Example |
| 1 | Set Id - Pid | SI | No | |
| 2 | Patient Id | CX | No | |
| 3 | Patient identifier list | CX | Yes | |
| 4 | Alternate patient Id - Pid | CX | No | |
| 5 | Patient name | XPN | Yes | HL7 2.4 |
| 6 | Mother's maiden name | XPN | No | |
| 7 | Date/time of birth | TS | No | * |
| 8 | Administrative sex | IS | No | * |
| 9 | Patient alias | XPN | No | |
| 10 | Race | CE | No | |
| 11 | Patient address | XAD | No | * |
| 12 | County code | IS | No | * |
| 13 | Phone number - home | XTN | No | |
| 14 | Phone number - business | XTN | No | |
| 15 | Primary language | CE | No | |
| 16 | Marital status | CE | No | |
| 17 | Religion | CE | No | |
| 18 | Patient account number | CX | No | * |
| 19 | SSN number - patient | ST | No | |
| 20 | Driver's license number - patient | DLN | No | |
| 21 | Mother's identifier | CX | No | |
| 22 | Ethnic group | CE | No | |
| 23 | Birth place | ST | No | |
| 24 | Multiple birth indicator | ID | No | |
| 25 | Birth order | NM | No | |
| 26 | Citizenship | CE | No | |
| 27 | Veterans military status | CE | No | |
| 28 | Nationality | CE | No | |
| 29 | Patient death date and time | TS | No | |
| 30 | Patient death indicator | ID | No | |
| 31 | Identity unknown indicator | ID | No | |
| 32 | Identity reliability code | IS | No | |
| 33 | Last update date/time | TS | No | |
| 34 | Last update facility | HD | No | |
| 35 | Species code | CE | No | |
| 36 | Breed code | CE | No | |
| 37 | Strain | ST | No | |
| 38 | Production class code | CE | No | |
| 39 | Tribal citizenship | CWE | No | |

### 4.3 ORC—Common Order

| | Name | Data type | Required | Example |
|---|---|---|---|---|
| 1 | Order control | ID | Yes | 1 |
| 2 | Placer order number | EI | No | |
| 3 | Filler order number | EI | No | |
| 4 | Placer group number | EI | No | |
| 5 | Order status | ID | No | |
| 6 | Response flag | ID | No | |
| 7 | Quantity/timing | TQ | No | |
| 8 | Parent | EIP | No | |
| 9 | Date/time of transaction | TS | No | |
| 10 | Entered by | XCN | No | |
| 11 | Verified by | XCN | No | |
| 12 | Ordering provider | XCN | No | |
| 13 | Enterer's location | PL | No | |
| 14 | Callback phone number | XTN | No | |
| 15 | Order effective date/time | TS | No | |
| 16 | Order control code reason | CE | No | |
| 17 | Entering organization | CE | No | |
| 18 | Entering device | CE | No | |
| 19 | Action by | XCN | No | |
| 20 | Advanced beneficiary notice | CE | No | |
| | code | | | |
| 21 | Ordering facility name | XON | No | |
| 22 | Ordering facility address | XAD | No | |
| 23 | Ordering facility phone number | XTN | No | |
| 24 | Ordering provider address | XAD | No | |
| 25 | Order status modifier | CWE | No | |
| 26 | Advanced beneficiary notice | CWE | No | |
| 27 | Filler's expected availability | TS | No | |
| 28 | Confidentiality code | CWE | No | |
| 29 | Order type | CWE | No | |
| 30 | Enterer authorization mode | CNE | No | |

### 4.4 OBR—Observation Request

| | | Data | | |
|---|---|---|---|---|
| | Name | type | Required | Example |
| 1 | Set Id - OBR | SI | No | |
| 2 | Placer order number | EI | No | |
| 3 | Filler order number | EI | No | |
| 4 | Universal service identifier | CE | Yes | Readings |
| 5 | Priority₋ OBR | ID | No | |
| 6 | Requested date/time | TS | No | |
| 7 | Observation date/time | TS | Yes | 1st reading |
| 8 | Observation end date/time | TS | Yes | Last |
| | | | | reading |
| 9 | Collection volume | CQ | No | |
| 10 | Collector identifier | XCN | No | |
| 11 | Specimen action code | ID | No | |
| 12 | Danger code | CE | No | |
| 13 | Relevant clinical information | ST | No | |
| 14 | Specimen received date/time | TS | No | |
| 15 | Specimen source | SPS | No | |
| 16 | Ordering provider | XCN | No | |
| 17 | Order callback phone number | XTN | No | |
| 18 | Placer field 1 | ST | No | |
| 19 | Placer field 2 | ST | No | |
| 20 | Filler field 1 | ST | No | |
| 21 | Filler field 2 | ST | No | |
| 22 | Results rpt/status chng - date/time | TS | No | |
| 23 | Charge to practice | MOC | No | |
| 24 | Diagnostic serv sect Id | ID | No | |
| 25 | Result status | ID | No | |
| 26 | Parent result | PRL | No | |
| 27 | Quantity/timing | TQ | No | |
| 28 | Result copies to | XCN | No | |
| 29 | Parent | EIP | No | |
| 30 | Transportation mode | ID | No | |
| 31 | Reason for study | CE | No | |
| 32 | Principal result interpreter | NDL | No | |
| 33 | Assistant result interpreter | NDL | No | |
| 34 | Technician | NDL | No | |
| 35 | Transcriptionist | NDL | No | |
| 36 | Scheduled date/time | TS | No | |
| 37 | Number of sample containers | NM | No | |
| 38 | Transport logistics of collected | CE | No | |
| | sample | | | |
| 39 | Collector's comment | CE | No | |
| 40 | Transport arrangement | CE | No | |
| | responsibility | | | |
| 41 | Transport arranged | ID | No | |
| 42 | Escort required | ID | No | |
| 43 | Planned patient transport comment | CE | No | |
| 44 | Procedure code | CE | No | |
| 45 | Procedure code modifier | CE | No | |
| 46 | Placer supplemental service info | CE | No | |
| 47 | Filler supplemental service info | CE | No | |
| 48 | Medically necessary duplicate | CWE | No | |
| | procedure reason | | | |
| 49 | Result handling | IS | No | |

NOTES:
1) Field 7, Date/time of message is in the format YYYYMMDDHHMMSS

### 4.5 OBX—Observation/result

| | | Data | | |
|---|---|---|---|---|
| | Name | type | Required | Example |
| 1 | Set Id - obx | SI | Yes | |
| 2 | Value type | ID | No | |
| 3 | Observation identifier | CE | Yes | |
| 4 | Observation sub-id | ST | No | |
| 5 | Observation value | ST | Yes | |
| 6 | Units | CE | Yes | |
| 7 | References range | ST | No | |
| 8 | Abnormal flags | IS | No | |
| 9 | Probability | NM | No | |
| 10 | Nature of abnormal test | ID | No | |
| 11 | Observation result status | ID | Yes | F |
| 12 | Effective date of reference range | TS | No | |
| 13 | User defined access checks | ST | No | |
| 14 | Date/time of the observation | TS | Yes | |
| 15 | Producer's Id | CE | No | |
| 16 | Responsible observer | XCN | No | |
| 17 | Observation method | CE | No | |
| 18 | Equipment instance identifier | EI | No | |
| 19 | Date/time of the analysis | TS | No | |

### 4.6 MSA—Message Acknowledgment

| | | Data | | |
|---|---|---|---|---|
| | Name | type | Required | Example |
| 1 | Acknowledgment code | ID | Yes | AA |
| 2 | Message control Id | ST | Yes | MSH 10 |
| 3 | Text message | ST | No | |
| 4 | Expected sequence number | NM | No | |
| 5 | Delayed acknowledgment type | ID | No | |
| 6 | Error condition | CE | Yes | See notes |

Notes:
Field 1, acknowledgment code is one of AA and AR for rejected messages.
Field 2, message control Id is the MSH 10 of the original message.
Field 6, error condition is a CE date type. The first two subfields identifier and text are used. The identifier is 0 for accepted messages otherwise an error code. The text is empty for accepted messages otherwise an error string.

### 4.7 ERR—Error

| | | Data | | |
|---|---|---|---|---|
| | Name | type | Required | Example |
| 1 | Error code and location | ELD | No | |
| 2 | Error location | ERL | No | |
| 3 | HL7 error code | CWE | Yes | See notes |
| 4 | Severity | ID | Yes | |
| 5 | Application error code | CWE | No | |
| 6 | Application error parameter | ST | No | |
| 7 | Diagnostic information | TX | No | |
| 8 | User message | TX | No | |
| 9 | Inform person indicator | IS | No | |
| 10 | Override type | CWE | No | |
| 11 | Override reason code | CWE | No | |
| 12 | Help desk contact point | XTN | No | |

Notes:
Field 3, HL7 error code is the same as field 6 (error condition) of the MSA segment.

### APPENDIX B

### Devices

### 5 Devices

### 5.1 Device Types Supported by Service Provider

| Devices | Device Type ID |
|---|---|
| AirWatch | AIRWATCH |
| LifeScan Profile | LSPROF2 |
| LifeScan Fast Take | LSFTAKE |
| Omron IC | OMRON |
| OneTouch II | LSOT2 |
| LifeScan SureStep | LSSSTEP |
| MediSense Precision Xtra | MDPREC |
| Uplink Plus | REPORT2 |
| LifeScan Basic | LSBASIC |
| One Touch Ultra | LSULTRA |
| MetrikLink | METRIKLINK |
| Therasense Freestyle | FREESTYLE |
| Bayer Glucometer Elite XL | BAYERELITEXL |
| Bayer DEX | BAYERDEX |
| Bayer DEX 2 | BAYERDEX2 |
| Ascensia Elite XL | ASCENSIAELITEXL |
| Ascensia Breeze | ASCENSIABREEZE |
| BD Paradigm Link | BDPARADIGM |
| BD Logic | BDLOGIC |
| InDuo | INDUO |
| D-TRON Plus | DTRONPLUS |
| D-TRON Pump | DTRON |
| Meditronic MiniMed | MINIMED |
| A&D UA-767PC Blood Pressure | LIFESOURCEUA767PC |
| Monitor (Arm) | |
| One Touch UltraSmart | LSULTRASMART |
| Precision QID | MDPRECQID |
| BD Latitude | BDLATITUDE |
| Prestige Smart System | HDIPRESTIGE |
| TrueTrack Smart System | HDITRUETRACK |
| Accu-Chek Complete | ROCHECOMPLETE |
| Accu-Chek Advantage | ROCHEADVANTAGE |
| Accu-Chek Advantage (New) | ROCHEADVANTAGEII |
| Accu-Chek Compact | ROCHECOMPACT |
| Accu-Chek Compact Plus | ROCHECOMPACTPLUS |
| Accu-Chek Active | ROCHEACTIVE |
| Omron Blood Pressure-HEM | OMRONHEM705CP |
| 705CP-(Arm) | |
| Omron Blood Pressure-HEM 637- | OMRONHEM637 |
| (Wrist) | |
| Ascensia Contour | ASCENSIACONTOUR |
| Therasense Freestyle Flash | FREESTYLEFLASH |
| Therasense Freestyle Mini | FREESTYLEMINI |
| Accu-Chek Aviva | ROCHEAVIVA |
| A&D UC-321PL Scale | LIFESOURCE UC-321PL |
| One Touch Ultra 2 | LSULTRA2 |
| Therasense Freestyle Freedom | FREESTYLEFREEDOM |

HL7 General Description

As described above, HL7 is used in the described embodiment as a means for transmitting data. It is one of several American National Standards Institute Organizations (SDOs) operating in the healthcare arena. Most SDOs produce standards (sometimes called specifications or protocols) for a particular healthcare domain such as pharmacy, medical devices, imaging or insurance (claims processing) transactions. Health Level Seven's domain is clinical and administrative data. Its members—providers, vendors, payers, consultants, government groups and others who have an interest in the development and advancement of clinical and administrative standards for healthcare—develop the standards. Like all ANSI-accredited SDOs, Health Level Seven adheres to a strict and well-defined set of operating procedures that ensures consensus, openness and balance of interest. Health Level Seven develops specifications (not software), the most widely used being a messaging standard that enables disparate healthcare applications to exchange keys sets of clinical and administrative data.

Version 3 of HL7 offers optionality and flexibility. There is neither a consistent view of that data that HL7 moves nor that data's relationship to other data. HL7's success is also largely attributable to its flexibility. It contains many optional data elements and data segments, making it adaptable to almost any site. While providing great flexibility, its optionality also makes it impossible to have reliable conformance tests of any vendor's implementation and also forces implementers to spend more time analyzing and planning their interfaces to ensure that both parties are using the same optional features. Version 3 addresses these and other issues by using a well-defined methodology based on a reference information (i.e., data) model. Using rigorous analytic and message building techniques and incorporating more trigger events and message formats with very little optionality, HL7's primary goal for Version 3 is to offer a standard that is definite and testable, and provide the ability to certify vendors' conformance. Version 3 uses an object-oriented development methodology and a Reference Information Model or RIM to create messages. The RIM is an essential part of the HL7 Version 3 development methodology, as it provides an explicit representation of the semantic and lexical connections that exist between the information carried in the fields of HL7 messages. Information on HL7 Version 3 is available in the document titled HL7 Version 3-Message Type Language (METL) Description, draft published Jan. 26, 1999, from the HL7 Organization, incorporated by reference herein in its entirety for all purposes.

Although illustrative embodiments and applications of this invention are shown and described herein, many variations and modifications are possible which remain within the concept, scope, and spirit of the invention, and these variations would become clear to those of ordinary skill in the art after perusal of this application. For example, although the embodiments are described using HL7 other standards, protocols, and specifications may be used. Similarly, MediCompass is used to illustrate one example of data hub 104, but other data repositories may also be suitable as a data hub and for performing the services described above. Accordingly, the embodiments described are to be considered as illustrative and not restrictive, and the invention is not to be limited to the details given herein, but may be modified within the scope and equivalents of the appended claims.

We claim:

1. A method a managing health-related data comprising:
receiving health data for a plurality of data providers, wherein the health data is either transmitted using the Health Level Seven (HL7) specification or is transmitted in a proprietary format using a known protocol;
translating health data in a proprietary format to HL7-conforming format for storage;
storing the health data in a data hub having a plurality of personal health records, wherein a PHR stores the health data having multiple formats;
transmitting a portion of the health data to one or more data consumers using the HL7 specification,
wherein the data hub performs as a central, standardized data hub capable of providing a continuous health data feed to data consumers.

2. A computer system comprising:
one or more processors;
an output network interface and an input network interface;
a memory for storing
a plurality of personal health records, a personal health record having fields for storing data in a proprietary format or in a standard format;
an Health Level Seven (HL7) translation module; and
a data insertion/retrieval code module,
wherein the computer system performs as a standardized health data repository for various entities in the healthcare industry.
